(19) United States
(12) Patent Application Publication
(10) Pub. No.: US 2016/0323233 A1
(43) Pub. Date: Nov. 3, 2016

(54) METHOD AND SYSTEM FOR PROVIDING TRAFFIC INFORMATION-BASED SOCIAL NETWORK SERVICE

(71) Applicant: KOREA NATIONAL UNIVERSITY OF TRANSPORTATION INDUSTRY-ACADEMIC COOPERATION FOUNDATION, Chungju-si (KR)

(72) Inventors: Seok Il SONG, Chungju-si (KR); Dong Gun LIM, Chungju-si (KR); Cheol MUN, Yongin-si (KR)

(73) Assignee: Korea National University of Transportation Industry-Academic Cooperation Foundation, Chungju-si (KR)

(21) Appl. No.: 15/107,458

(22) PCT Filed: Dec. 22, 2014
(86) PCT No.: PCT/KR2014/012650

§ 371 Date: Jun. 22, 2016

(30) Foreign Application Priority Data
Dec. 23, 2013 (KR) 10-2013-0160925

(51) Int. Cl. H04L 12/58; G08G 1/09; G08G 1/01; H04L 29/08; H04W 4/04

(52) U.S. Cl. CPC H04L 51/32; H04L 67/18; H04W 4/046; G08G 1/0112; G08G 1/093

(57) ABSTRACT

Disclosed are a method and a system for providing a traffic information-based social network service, which provides traffic information between vehicles or between a vehicle and a user terminal through a social network service, wherein traffic information is shared between vehicles or between a vehicle and the mobile device of a person through a social network service.

### BACKGROUND OF THE INVENTION

1. Technical Field

The present invention relates to a method and system for providing a social network service based on traffic information, wherein traffic information is shared between vehicles or between a vehicle and the mobile device of a person through a social network service.

2. Description of the Related Art

Wireless networking in a vehicle may be classified as Vehicle to Infrastructure (V2I) communication, Vehicle to Vehicle (V2V) communication, and Vehicle to Nomadic device (V2N) communication. An object of developing the technologies of V2I and V2V is to improve a road safety.

As an intelligent traffic system is recently grafted onto the development of wireless communication technologies, a variety of Intelligent Technologies (IT) additional services are made possible. The variety of IT additional services chiefly include additional services using multimedia data, such as video or image data.

Furthermore, as mobile devices are spread along with the development of the wireless communication technologies, social network services are widely used. An example of a prior art in which traffic information is shared using such a social network is disclosed in Korean Patent Application Publication No. 10-2012-0133635. A system for automatically sharing traffic information in the publication is configured to periodically collect vehicle information, to write a traffic situation message for whether an accident has occurred in the collected vehicle information and for a traffic situation, to send the traffic situation message to a social network server, to receive the traffic situation message of another vehicle, and to display the received traffic situation message. Through such a configuration, actual traffic situation information is shared between vehicles using a social network without constructing separate infrastructure.

The social network server of the aforementioned prior art performs the same function as an existing traffic control center. That is, the aforementioned prior art is configured to share traffic information using the social network server instead of the existing traffic control center. However, the aforementioned prior art has a disadvantage in that the social network server is used as a relay device for transmitting and receiving traffic situation messages, but it is difficult to use traffic information suitable for its own location or current time through the social network server.

### SUMMARY OF THE INVENTION

Accordingly, in an embodiment of the present invention, there are provided a method and system for providing a social network service based on traffic information, wherein traffic information can be effectively shared between vehicles and between a vehicle and mobile device of a person through a social network service.

In another embodiment of the present invention, there are provided a method and system for providing a social network service based on traffic information, wherein a friend group of a social network service can be dynamically generated based on the current location and moving direction of a vehicle and mutual traffic information can be shared through the social network service.

In yet another embodiment of the present invention, there are provided a method and system for providing a social network service based on traffic information, wherein traffic information can be extracted from various messages generated by the mobile device of a person and can be provided in a standardized traffic information from through a friend group of a social network service.

In order to achieve the objects, a system for providing a social network service based on traffic information according to an aspect of the present invention is a system for providing a social network service based on traffic information, including a social network server connected to the traffic information association apparatuses of a plurality of vehicles through wireless communication. The social network server is configured to include a communication unit which receives location information or navigation information or a combination of them from the traffic information association apparatuses of the plurality of vehicles; a group generation unit which generates a second vehicle within a specific distance from a first vehicle, a third vehicle moving on the same road as the first vehicle, a fourth vehicle having a second destination within a specific distance from the first destination of the first vehicle or a combination of them as the friend group of the first vehicle based on the location information or the navigation information; and a posting unit which posts event-related traffic data defined as a driver state, a vehicle state, a road state, a road condition or a combination of them from the first traffic information association apparatus of the first vehicle on the first social network service area of the friend group.

In accordance with an embodiment of the present invention, there can be provided a method and system for providing a social network service based on traffic information, wherein traffic information is effectively shared between vehicles and between a vehicle and mobile device of a person through a social network service.

In accordance with another embodiment of the present invention, there can be provided a method and system for providing a social network service based on traffic information, wherein a friend group of a social network service is dynamically generated based on the current location and moving direction of a vehicle and mutual traffic information is shared through the social network service.

In accordance with yet another embodiment of the present invention, there can be provided a method and system for providing a social network service based on traffic information, wherein traffic information is extracted from various messages generated by the mobile device of a person and is provided in a standardized traffic information from through a friend group of a social network service.

### BRIEF DESCRIPTION OF THE DRAWINGS

FIG. 1 is an exemplary diagram of an intelligent traffic system using a system for providing a social network service based on traffic information (hereinafter simply called an “SNS providing system”) according to an embodiment of the present invention.

FIG. 2 shows a schematic configuration of the SNS providing system of FIG. 1.

FIG. 3 is a flowchart illustrating the service providing method of the SNS providing system of FIG. 1.

FIG. 4 is a block diagram of a social network server of FIG. 2.

FIG. 5 is a flowchart illustrating an operating method of the social network server of FIG. 4.

FIG. 6 is a flowchart illustrating an additional operating method of the social network server of FIG. 5.

FIG. 7 is a block diagram of a traffic information association apparatus of FIG. 2.

FIG. 8 is a flowchart illustrating an operating method of a traffic information association apparatus of FIG. 7.

FIG. 9 is a flowchart illustrating an additional operating method of the traffic information association apparatus of FIG. 7.

### DESCRIPTION OF REFERENCE NUMERALS

10: social network server
11: communication unit
12: group generation unit
13: posting unit
14: traffic information mining unit
15: message transmission unit
20: traffic information association apparatus
21: communication unit
22: social network association unit
23: traffic information extraction unit
24: collection unit
25: storage unit
26: sensing unit

### DETAILED DESCRIPTION

Hereinafter, preferred embodiments of the present invention are described in detail with reference to the accompanying drawings. In describing the embodiments, however, a detailed description of the known function or element related to the present invention will be omitted if it is deemed to make the gist of the present invention unnecessarily vague. Furthermore, in the drawings, in order to clarify a description of the present invention, a description of parts not related to the description is omitted, and similar reference numbers are used throughout the specification to refer to similar parts.

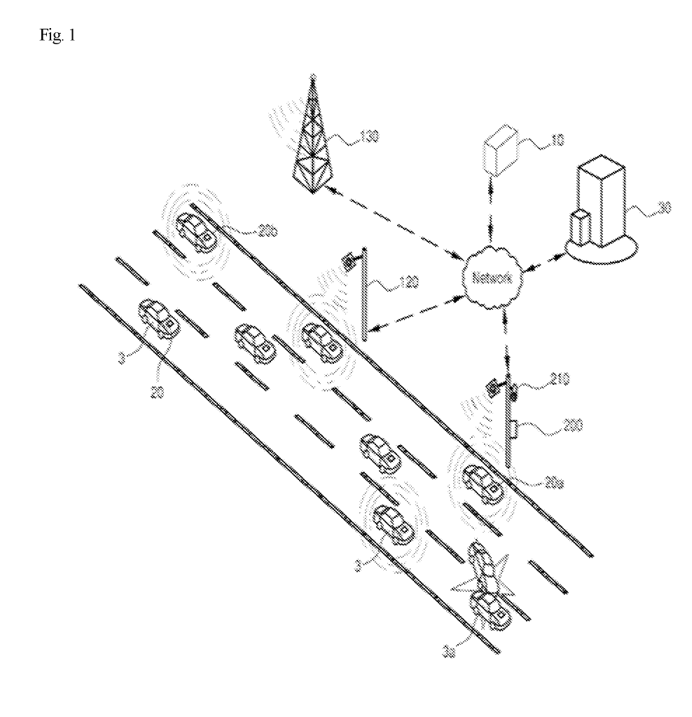

FIG. 1 is an exemplary diagram of an intelligent traffic system using a system for providing a social network service based on traffic information (hereinafter simply called an “SNS providing system”) according to an embodiment of the present invention.

Referring to FIG. 1, the intelligent traffic system according to the present embodiment supports communication between vehicles 3 and communication between the vehicles 3 and infrastructure so that traffic information is shared between the vehicles, thereby improving traffic safety. In this case, the infrastructure includes a roadside base station 120 including a WAVE base station 200, the base station 130 of a mobile communication network, a traffic information collection apparatus 210 and so on. The roadside base station 12, the base station 130 of a mobile communication network, and the traffic information collection apparatus 210 are connected to a social network server 10 or a traffic control center 30 over a wireless or wired network.

The social network server 10 is one of the major elements of the system for providing a social network service based on traffic information. The social network server 10 generates vehicles which are moving in a specific area or on a specific road or have a specific destination as a real-time friend group based on location information received from the traffic information association apparatuses 20, 20a, and 20b of a plurality of vehicles, and provides a service so that traffic information is shared within the friend group.

Furthermore, the social network server 10 mines traffic information obtained from the message (a text message, a multimedia message and so on) of the mobile device of a user who uses the social network service of the social network server and has got in a moving vehicle, and provides customized traffic data to each of a plurality of friend groups according to the locations or destinations of vehicles.

The traffic information association apparatus 20, 20a or 20b is one of the major elements of the system for providing a social network service based on traffic information. The traffic information association apparatus is mounted on the vehicle 3, and collects traffic data in response to a user definition event and stores and manages the collected traffic data based on predetermined priority or importance.

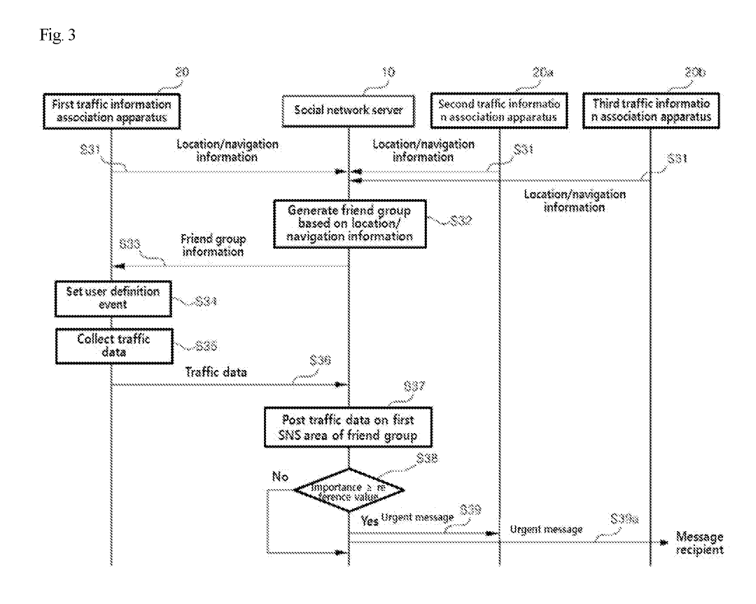

In this case, the user definition event includes a driver state, a vehicle state, a road state, a road condition or a combination of them. Regarding the priority or the importance, case where the driver state of the user definition event is “driving while drowsy”, the case where the vehicle state thereof is sudden braking, a breakdown, a car accident (refer to FIG. 3a) or a combination of them, the case where the road state thereof is ice formation, slipperiness, a loss, an obstacle or a combination of them, or the case where the road condition thereof is a traffic jam or delayed traffic may be set to have higher priority or importance that other cases.

Furthermore, the traffic information association apparatus 20 sends a predetermined signal or data, such as the location and traffic data of a vehicle, to the social network server 10. Specifically, the traffic information association apparatus 20 extracts traffic information from messages transmitted to and received from the mobile device of a vehicle user, and sends the traffic information to the social network server 10. The messages transmitted to and received from the mobile device may include text messages, multimedia messages and so on.

The aforementioned WAVE base station 200 may be implemented so that it supports a Wireless Access Vehicle Environment (WAVE) between a vehicle and infrastructure in the situation in which the vehicle moves at a speed of about 160 km/h. Such WAVE communication may be applied to the communication unit of the traffic information association apparatus 20 for communication between vehicles.

The aforementioned traffic information collection apparatus 210 may be configured to include a communication module and a camera which are devices for capturing images of a road and a moving object on a road within a photographing range and sending the captured images to the traffic control center.

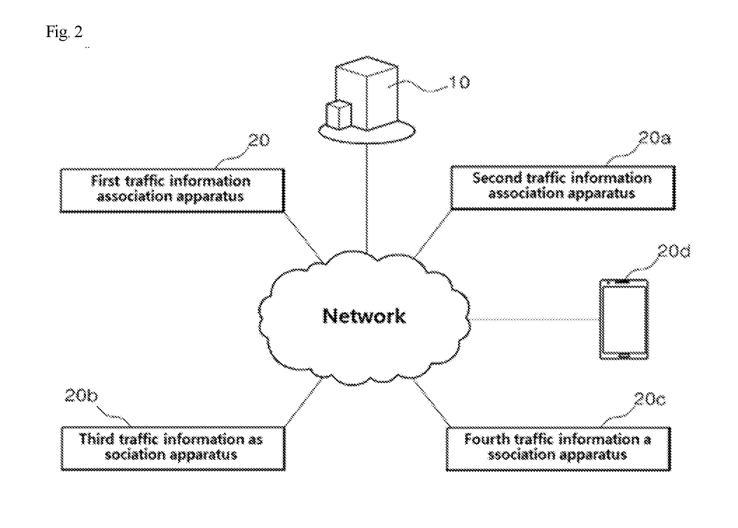

FIG. 2 shows a schematic configuration of the SNS providing system of FIG. 1.

Referring to FIG. 2, the SNS providing system according to the present embodiment is configured to include at least one social network server 10 and a plurality of traffic information association apparatuses 20, 20a, 20b, and 20c interconnected over a network.

The network includes networks of a wireless communication method, such as a WAVE communication network, a mobile communication network, and a satellite network. Furthermore, the network may include a network of a wired communication method connected to a network of a wireless communication method. The network of a wired communication method may include a short-distance communication network, a public switched telephone network, the Internet and so on.

The social network server 10 provides an on-line platform through which communication can be freely performed and information can be shared between registered users. The social network server 10 generates a friend group in a web, that is, a world-wide information space, and provides a service so that traffic data is shared between friends within the friend group.

Specifically, the social network server 10 according to the present embodiment generates a real-time friend group based on the location of the vehicle of a user who uses the social network service so that traffic data received from the traffic information association apparatuses of vehicles belonging to the friend group is shared within the friend group, and provides customized traffic information to the vehicles within the friend group through the social network service.

The plurality of traffic information association apparatuses 20, 20a, 20b, and 20c are mounted on different vehicles, send traffic data to the social network server 10, and receive customized traffic data from the social network server through a friend group. The plurality of traffic information association apparatuses of the present embodiment is substantially the same except that they operate in different vehicles. Accordingly, a specific traffic information association apparatus 20 is chiefly described below.

A camera may be integrated and mounted on the traffic information association apparatus 20, or the traffic information association apparatus 20 may be connected to a vehicle-mounted camera. Furthermore, the traffic information association apparatus 20 is connected to a variety of types of sensors of a corresponding vehicle, and may obtain the vehicle state or location information. The variety of types of sensors may include a Global Positioning System (GPS) device for receiving positioning signals from GPSs. Alternatively, the traffic information association apparatus 20 may be detachably installed on the vehicle or may be a separate mobile device 20d of a vehicle user.

That is, the traffic information association apparatus 20 may be implemented using a navigator, a traffic information terminal, etc. for a vehicle or may correspond to a device implemented by installing a program or application for a traffic information association function on the mobile device of a user having a wireless communication function, such as WAVE communication. For example, the mobile device 20d may be implemented so that it includes a communication interface connected to a camera and vehicle sensors and it is connected to the social network server 10 through a wireless communication module. Such a mobile device may be any one of iPhone, iPad, Galaxy Note series, Galaxy tap series, and Optimus G series, but is not limited thereto.

FIG. 3 is a flowchart illustrating the service providing method of the SNS providing system of FIG. 1.

The SNS providing system according to the present embodiment generates a friend group in which current locations or destinations are correlated based on the location information or navigation information of the traffic information association apparatuses of a plurality of vehicles so that traffic data collected from the traffic information association apparatuses of the vehicles, specifically, traffic data including the user definition event, is shared within the friend group of the social network service which is changed periodically or dynamically in real time. Accordingly, real-time customized traffic data related to the driving of a vehicle can be obtained and used very effectively.

The service providing method is described in more detail with reference to FIG. 3. The first traffic information association apparatus 20 sends location information or navigation information or both to the social network server 10 (S31). Likewise, the second traffic information association apparatus 20a and the third traffic information association apparatus 20b also send their location and/or navigation information to the social network server 10 (S31). In this case, it is assumed that the first to the third traffic information association apparatuses 20, 20a, and 20b have already joined a traffic information-based social network service.

Next, when the location information or the navigation information is received from the traffic information association apparatuses of a plurality of vehicles, the social network server generates correlated vehicles (or users thereof) in their locations or destinations or the like as a specific friend group (corresponding to a first friend group) based on the location information (latitude, longitude, etc.) or the navigation information (the address or road name, etc. of a source, an intermediate stop, and a destination) or both in accordance with a specific program or predetermined policy for the social network service based on traffic information (S32). The first friend group may be named based on a specific area name or location name or road name.

The first friend group may be a group generated to include a second vehicle which is placed within a specific range from a first vehicle based on the first vehicle, a third vehicle which moves on the same road as (or road section) as the first vehicle, a fourth vehicle which has a second destination within a specific distance from the first destination of the first vehicle, or a combination of them as its members.

After step S32, the social network server 10 may send friend group information, including a friend list belonging to a first SNS area, to the first traffic information association apparatus 20 operating in the first vehicle (S33).

Although not shown, the social network server 10 may send the friend group information, including the friend list belonging to the first SNS area, to the second traffic information association apparatus 20a operating in the second vehicle. In this case, it is assumed that the second vehicle is placed within a specific range from the first vehicle or moves on the same road as the first vehicle or has a destination similar to that of the first vehicle.

Furthermore, the social network server 10 may send friend group information, including a friend list belonging to a second SNS area different from the first SNS area, to the third traffic information association apparatus 20b operating in the third vehicle. In this case, it is assumed that the third vehicle is not placed within a specific distance from the first vehicle or does not move on the same road as the first vehicle and has a destination different from that of the first vehicle.

Next, the first traffic information association apparatus 20 collects event-related traffic data, including an event, from the camera or the vehicle sensors in accordance with the setting of the user definition event (S34, S35). The first traffic information association apparatus 20 may store and manage the collected traffic data in its storage device according to priority or importance. Furthermore, the first traffic information association apparatus 20 sends the traffic data to the social network server 10 (S36). Although not shown, the second traffic information association apparatus 20a and the third traffic information association apparatus 20b send different traffic data to the social network server 10.

Next, the social network server 10 posts the traffic data from the first traffic information association apparatus 20 on the first SNS area formed by the first friend group (S37). All of friend traffic information association apparatuses or mobile devices within the first friend group may access the server 10 and view or output the traffic data posted on the first SNS area.

Meanwhile, the social network server 10 determines whether the priority or importance included in the metadata of the traffic data is a reference value or more (S38). The social network server 10 may send an emergency message to the traffic information association apparatuses or traffic information terminals or user mobile devices within the first friend group (S39) or send the emergency message to a predetermined separate message recipient (a family, etc.) based on a result of the determination (S39a).

In accordance with the present embodiment, the intelligent traffic system can provide a social network service based on traffic information through a combination of a friend group and a user definition event. That is, the intelligent traffic system can notify the user of a surrounding vehicle of the state of the driver of a specific vehicle, obtained from a vehicle-mounted camera, vehicle sensors, or a smart phone, through the social network service or notify a message recipient (a family, an offline friend, etc.) of the state of the driver of the specific vehicle so that the user of the surrounding vehicle or the message recipient makes contact with/communicates with the driver of the specific vehicle. Accordingly, a traffic accident attributable to “driving while drowsy”, etc.” can be prevented.

Furthermore, the intelligent traffic system can prevent an accident by sending traffic information, such as a road surface state, an accident on a road, and the current moving speed detected by the first vehicle, to vehicles that move in the same direction or an opposite direction in a similar time zone, and can provide the traffic information to the traffic control center that monitors traffic information, thereby being capable of contributing to the provision of a route detour service by the traffic control center. Furthermore, the intelligent traffic system can effectively support safe group driving of vehicles within a friend group because the moving speeds, current locations, and destinations of the respective vehicles are shared with friends within the friend group in real time.

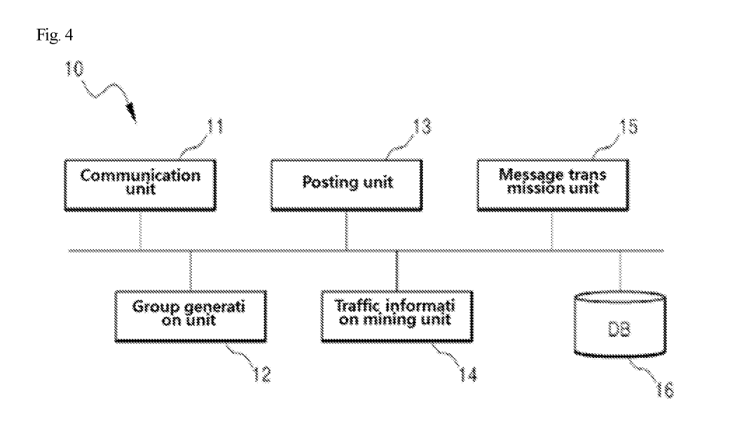

FIG. 4 is a block diagram of the social network server of FIG. 2.

Referring to FIG. 4, the social network server 10 according to the present embodiment is configured to include a communication unit 11, a group generation unit 12, a posting unit 13, a traffic information mining unit 14, and a message transmission unit 15. The social network server 10 may include a database (DB) 16 for providing a service in which traffic information (traffic data) of friends can be obtained or shared through a friend group formed by friends based on the current location or a moving route along with a social network service.

The communication unit 11 receives location information, navigation information or a combination of them from the traffic information association apparatuses of the plurality of vehicles. Furthermore, the communication unit 11 receives traffic data from the traffic information association apparatuses.

The group generation unit 12 generates a friend group based on location information of the traffic information association apparatuses or the vehicles thereof. For example, the group generation unit 12 may generate a second vehicle within a specific distance from a first vehicle, a third vehicle that moves on the same road as the first vehicle, a fourth vehicle having a second destination within a specific distance from the first destination of the first vehicle or a combination of them as a first friend group for the first vehicle, the user of the first vehicle or the first traffic information association apparatus of the first vehicle.

When the traffic data is received from the first traffic information association apparatus through the communication unit 11, the posting unit 13 posts the traffic data on the first social network service area of the first friend group. In this case, the communication unit 11 posts traffic data, received from the traffic information association apparatus of another vehicle of the first friend group, on the first social network service area.

The traffic information mining unit 14 generates traffic data by mining traffic information received from the mobile device of a user who uses a social network service. In this case, the traffic information mining unit 14 may be implemented to extract some messages which are related to a user definition event or include predetermined words/terms or syntax from messages that are transmitted and received through the text message service or multimedia message service of a mobile communication company in a mobile device.

The message transmission unit 15 sends traffic data or an emergency message, generated based on the traffic data, to the traffic information association apparatus of each vehicle within a friend group or the mobile device of a predetermined message recipient based on a result of a determination of priority or importance of the traffic data.

The aforementioned group generation unit 12, posting unit 13, traffic information mining unit 14, and message transmission unit 15 may be implemented as at least one process of the social network server for providing a social network service based on traffic information by performing a program or application stored in memory or a storage medium. In this case, the processor may control the operations of the communication unit 11, the group generation unit 12, the posting unit 13, the traffic information mining unit 14, and the message transmission unit 15 in accordance with a procedure or policy stored in the database 16. That is, the group generation unit 12, the posting unit 13, the message transmission unit 14, and the controller 15 may be mounted on the processor for performing a program stored in the memory as one body, but are not limited thereto.

The database 16 stores traffic data received from the traffic information association apparatuses. The traffic data includes a user definition event. The user definition event may include a driver state, a vehicle state, a road state, a road condition or a combination of them. Furthermore, the database 16 stores a reference value for determining priority or importance of traffic data. If a user definition event and importance, such as those of Table 1 below, are used, a reference value may be 5.

TABLE 1

| | | | | Road |
|---|---|---|---|---|
| Importance | Driver state | Vehicle state | Road state | condition |
| 1 | | | | smooth |
| 2 | | | obstacle | delay |
| 3 | | | slipperiness | |
| 4 | | sudden braking | ice | |
| | | | formation | |
| 5 | driving while | failure/accident | swept away | congest |
| | drowsy | | | |

As shown in Table 1, the traffic data may be implemented to have the highest importance with respect to events for “driving while drowsy”, a breakdown, a car accident, a swept-away road, and a traffic jam as user definition events.

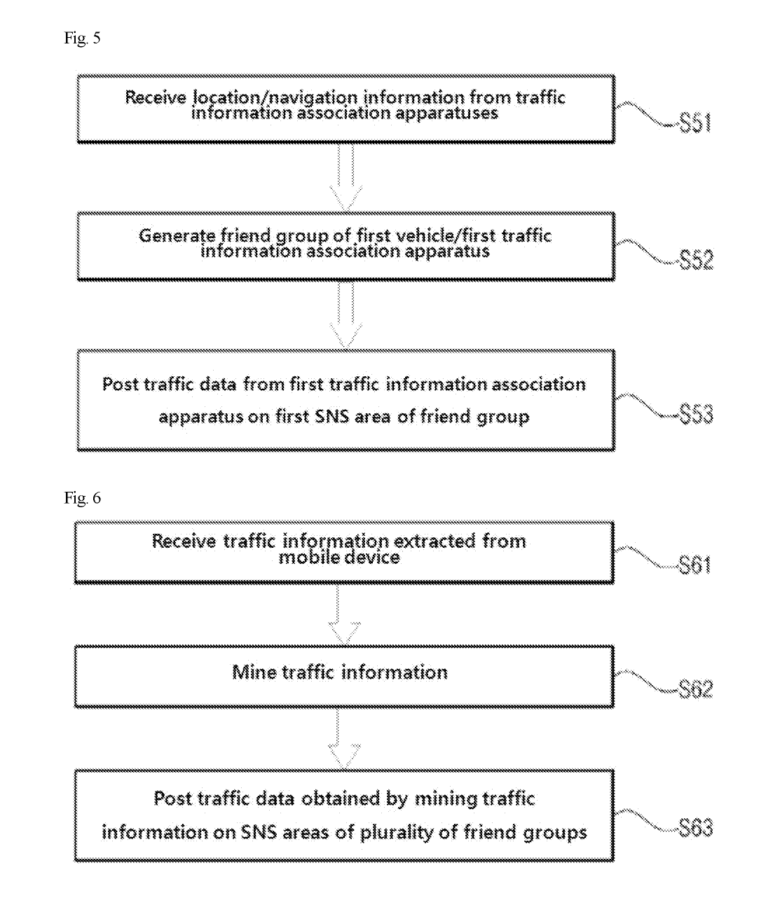

FIG. 5 is a flowchart illustrating an operating method of the social network server of FIG. 4.

Referring to FIG. 5, first, the social network server according to the present embodiment receives location information, navigation information or a combination of them from the traffic information association apparatuses of a plurality of vehicles (S51).

Next, the social network server generates a virtual friend group (a first friend group) for a social network service based on traffic information based on the location information or the navigation information (S52). For example, the social network server generates a second vehicle within a specific distance from a first vehicle, a third vehicle that moves on the same road as the first vehicle, a fourth vehicle that has a second destination within a specific distance from the first destination of the first vehicle or a combination of them as the friend group of the first vehicle or the first traffic information association apparatus of the first vehicle.

Next, the social network server receives traffic data, including a user definition event defined as a driver state, a vehicle state, a road state, a road condition or a combination of them, from the first traffic information association apparatus, and posts the received traffic data on the first social network service area of the first friend group (S53).

Meanwhile, the social network server may send the traffic data or an emergency message, generated based on the traffic data, to the traffic information association apparatus of the friend group or the mobile device of a predetermined message recipient based on a result of a determination of priority or importance of the traffic data.

FIG. 6 is a flowchart illustrating an additional operating method of the social network server of FIG. 5.

Referring to FIG. 6, the social network server according to the present embodiment receives traffic information, extracted from messages (text messages, multimedia messages, etc.) transmitted and received by the mobile device of a person who uses a social network service or all of mobile devices connected to the intelligent traffic system, from the mobile device of the corresponding user or the traffic information association apparatus connected to the mobile device (S61).

Next, the social network server mines the traffic information obtained from the text messages and multimedia messages transmitted and received by the mobile device of the user (S62).

Next, the social network server posts traffic data, obtained by mining the traffic information, on the SNS area of each of a plurality of friend groups (S63). In this case, the friend group may generate correlated vehicles as a single group based on location information or navigation information received from the traffic information association apparatuses of a plurality of vehicles.

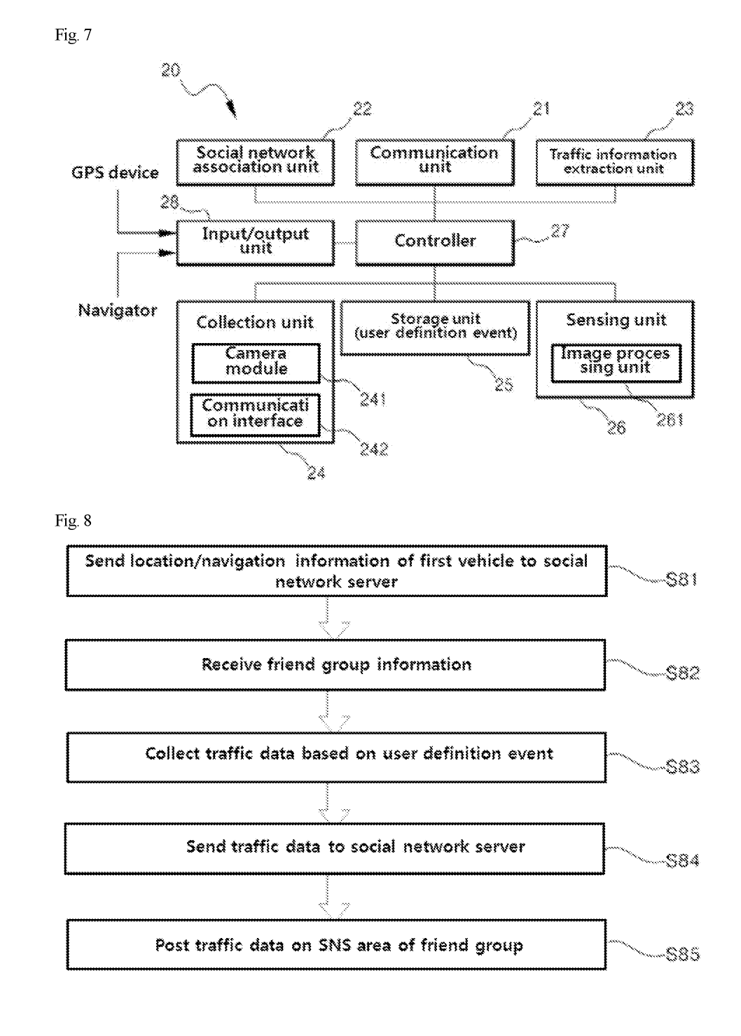

FIG. 7 is a block diagram of the traffic information association apparatus of FIG. 2.

Referring to FIG. 7, the traffic information association apparatus 20 according to the present embodiment is configured to include a communication unit 21, a social network association unit 22, a traffic information extraction unit 23, a collection unit 24, a storage unit 25, a sensing unit 26, a controller 27, and an input/output unit 28.

The communication unit 21 sends location information, navigation information or a combination of them about a first vehicle to the social network server. The communication unit 21 may be implemented as a communication module supporting a mobile communication network, specifically, WAVE communication.

Furthermore, the communication unit 21 is connected to the messaging service center of a network through wireless communication, and may transmit and receive text messages or multimedia messages. In this case, the traffic information association apparatus 20 may include a program or application capable of transmitting and receiving text messages or multimedia messages.

The social network association unit 22 receives friend group information, including a friend group, from the social network server. The friend group may be generated based on a second vehicle within a specific distance from a first vehicle, a third vehicle that moves on the same road as the first vehicle, a fourth vehicle that has a second destination within a specific distance from the first destination of the first vehicle or a combination of them based on the location information of the first vehicle.

The traffic information extraction unit 23 extracts traffic information, included in the transmitted and received messages of a mobile device, from a first traffic information association apparatus connected to the mobile device of a person who has rode on a first vehicle, and sends the extracted traffic information to the social network server through the communication unit 21. In this case, the traffic information extraction unit 23 may be implemented to be connected to the communication unit and to extract traffic data, including predetermined words or syntax, from the messages transmitted and received through the communication unit based on a user definition event. When the traffic information extracted from the messages is received, the social network server posts traffic data, generated by mining the traffic information, on the social network service area of a friend group related to the traffic information of the social network service.

The collection unit 24 collects traffic data, such as a driver state, a vehicle state, a road state, a road condition or a combination of them. The collection unit 24 may include a camera module 241 or may be connected to an external camera device through a communication interface 242. Furthermore, the collection unit 24 may be implemented to receive required information from a variety of types of sensors of a vehicle or a vehicle control device to which the sensors are connected.

The traffic data collected by the collection unit 24 is transmitted to the social network server through the communication unit 21. In this case, the collection unit 24 may send the traffic data, including a user definition event defined as a driver state, a vehicle state, a road state, a road condition or a combination of them related to a vehicle, to the social network server through the communication unit 21.

The storage unit 25 stores traffic data, configuration information for a user definition event, event-related traffic data, etc. The user definition event may include a driver state, a vehicle state, the road surface state of a road, a variety of types of accidents and obstacles on a road, the current vehicle moving speed, specific location information, a specific destination information and so on.

The sensing unit 26 analyzes and senses an event within traffic data. The sensing unit 26 may be configured to include an image processing unit 261 for processing an image signal. The image processing unit 261 may use at least one of the existing various image processing technologies. That is, the sensing unit may be implemented to sense traffic data including a user definition event through image processing. In this case, the traffic data includes image data or video data, and video data may be decomposed and converted into image data.

The controller 27 controls the operations of the communication unit 21, the social network association unit 22, the traffic information extraction unit 23, the collection unit 24, the storage unit 25, the sensing unit 26, and the input/output unit 28. The controller 27 may be implemented as a processor for performing a program or application (a social network service application based on traffic information, etc.) stored in the storage unit 25. Furthermore, the controller 27 may be integrated with a vehicle control device or may be implemented as part of the vehicle control device.

The input/output unit 28 may receive positioning signals from GPS devices and may receive navigation information from a navigator. Furthermore, the input/output unit 28 may receive signals from vehicle sensors. At least part of such an input/output unit 28 may be included in or integrated with the collection unit 24.

Furthermore, the input/output unit 28 may be configured to include an input unit for sensing input signals, such as the touch, voice, movement, etc. of a user and output units for generating output signals, such as a display device, a light-emitting device, a speaker, and a vibration sensor. For example, the input/output unit 28 may be a touch panel on a screen of a navigator or a traffic information terminal. In this case, the traffic information association apparatus may be implemented as a single device which uses a single housing along with the navigator.

FIG. 8 is a flowchart illustrating an operating method of the traffic information association apparatus of FIG. 7.

Referring to FIG. 8, in the method for providing a social network service based on traffic information according to the present embodiment, first, a traffic information association apparatus operating in a vehicle (corresponding to a first traffic information association apparatus) sends location information or navigation information or both of a first vehicle to the social network server through wireless communication (S81).

Next, the traffic information association apparatus receives friend group information from the social network server (S82).

Next, the traffic information association apparatus stores and manages traffic data (event-related traffic data), collected based on a user definition event by the camera or the vehicle sensors, according to priority or importance of the traffic data (S83).

Next, the traffic information association apparatus sends the traffic data from which an event was detected, that is, the event-related traffic data (corresponding to first event-related data), to the social network server (S84). In this case, the traffic data transmitted to the social network server is posted on the SNS area (first SNS area) of the corresponding friend group of a social network service based on traffic information (S85).

Meanwhile, the traffic information association apparatus may receive traffic data (corresponding to second event-related traffic data) which is generated from another traffic information association apparatus of the friend group and which is posted on the first SNS area from the social network server. Furthermore, the traffic information association apparatus may output traffic information or navigation information into which the event-related traffic data has been incorporated through the input/output unit (a display device).

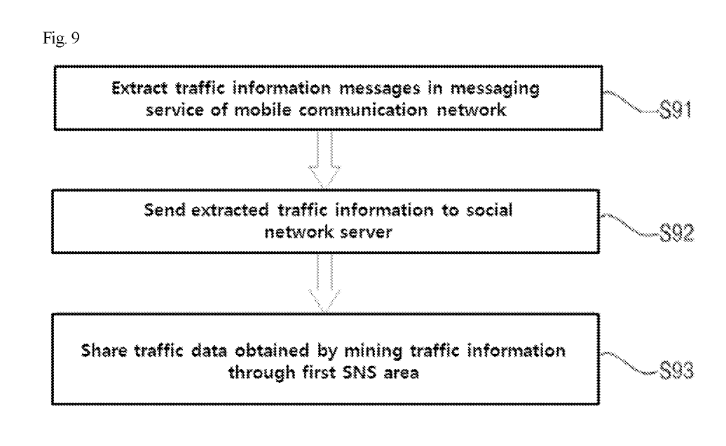

FIG. 9 is a flowchart illustrating an additional operating method of the traffic information association apparatus of FIG. 7.

Referring to FIG. 9, in the method for providing a social network service based on traffic information according to the present embodiment, first, a traffic information association apparatus, for example, a first traffic information association apparatus operating in a first vehicle extracts traffic information according to a user definition event from messages transmitted and received by the messaging service of a mobile communication network (S91).

Next, the first traffic information association apparatus sends the extracted traffic information to the social network server (S92). In this case, traffic data obtained by mining the traffic information is posted on the first friend group and shared through a first SNS area to which the first traffic information association apparatus or the first vehicle belongs (S93).

Although the present invention has been described based on the embodiments as described above, the embodiments are only illustrative and are not intended to limit the present invention. A person having ordinary skill in the art to which the present invention pertains may understand that various combination or modifications and applications not illustrated in the embodiments are possible without departing from the intrinsic technical contents of the present embodiment. Accordingly, technical contents related to modifications and applications that may be easily deduced from the embodiments of the present invention should be construed as being included in the present invention.

In accordance with an embodiment of the present invention, a friend group of a social network service can be dynamically generated based on the current location and moving direction of a vehicle, and mutual traffic information can be shared through the social network service. Furthermore, traffic information can be extracted from various messages generated from the mobile device of a person, and can be provided in a standardized traffic information form through the friend group of the social network service.

What is claimed is:

1. A system for providing a social network service based on traffic information, the system comprising a social network server connected to traffic information association apparatuses of a plurality of vehicles through wireless communication and the social network server comprising:
a communication unit which receives location information or navigation information or a combination of the location information or the navigation information from the traffic information association apparatuses of the plurality of vehicles;
a group generation unit which generates a second vehicle within a specific distance from a first vehicle, a third vehicle moving on a road identical with a road of the first vehicle, a fourth vehicle having a second destination within a specific distance from a first destination of the first vehicle or a combination of the second, the third, and the fourth vehicles as a friend group of the first vehicle based on the location information or the navigation information; and
a posting unit which posts event-related traffic data defined as a driver state, a vehicle state, a road state, a road condition or a combination of the driver state, the vehicle state, the road state, and the road condition from the first traffic information association apparatus of the first vehicle on a first social network service area of the friend group.

2. The system of claim 1, further comprising a traffic information mining unit which extracts the event-related traffic data by mining traffic information collected from messages on a message service of a mobile communication network,
wherein the messages comprise messages transmitted and received by mobile devices of a plurality of users who use the social network service, and
the event-related traffic data is shared by the mobile devices of the plurality of users or traffic information association apparatuses which belong to a plurality of friend groups of the social network service.

3. The system of claim 1, further comprising a message transmission unit which sends the event-related traffic data or an emergency message generated based on the event-related traffic data to the traffic information association apparatus within the friend group or a mobile device of a predetermined message recipient based on a result of a determination of importance of the event-related traffic data.

4. The system of claim 2, wherein:
the driver state comprises driving while drowsy,
the vehicle state comprises sudden braking, a breakdown, a car accident or a combination of the sudden braking, the breakdown, and the car accident,
the road state comprises ice formation, slipperiness, a swept-away road, an obstacle or a combination of the ice formation, the slipperiness, the swept-away road, and the obstacle,
the road condition comprises a traffic jam, delayed traffic or smooth traffic, and
the importance has a highest importance in the driving while drowsy, the breakdown, the car accident, the swept-away road, or the traffic jam as a user definition event.

5. A system for providing a social network service, the system comprising a traffic information association apparatus of a first vehicle connected to a social network server over a network and the traffic information association apparatus comprising:
a communication unit which wirelessly communicates with the social network server;
a traffic data collection unit which collects traffic data according to a user definition event defined as a driver state, a vehicle state, a road state, a road condition or a combination of the driver state, the vehicle state, the road state, and the road condition related to the first vehicle and location information or navigation information of the first vehicle; and
a social network association unit which receives friend group information from the social network server, wherein the friend group information comprises a friend group generated based on a second vehicle within a specific distance from the first vehicle, a third vehicle moving on a road identical with a road of the first vehicle, a fourth vehicle having a second destination within a specific distance from a first destination of the first vehicle or a combination of the second, the third, and the fourth vehicles based on the location information,
wherein the event-related traffic data transmitted to the social network server is posted on a first social network service area shared within the friend group.

6. The system of claim 5, further comprising a traffic information extraction unit which extracts traffic information from messages on wireless communication of the communication unit,
wherein the traffic information is transmitted to the social network server, mined by the social network server, posted on a second social network service area of a plurality of friend groups of the social network service comprising the first social network service area, and shared by mobile devices of a plurality of users or traffic information association apparatuses belonging to the plurality of friend groups.

7. The system of claim 6, wherein the traffic information extraction unit is connected to the communication unit and extracts the traffic information comprising predetermined words or syntax from messages transmitted and received through the communication unit.

8. The system of claim 7, wherein the traffic data collection unit classifies and stores the traffic data according to the user definition event of the driver state, the vehicle state, the road state, the road condition or the combination of the driver state, a vehicle state, the road state, the road condition based on priority.

9. The system of claim 8, wherein the priority is determined based on recentness of the traffic data and whether the traffic data comprises an image or video event.

10. A method for providing a social network service based on traffic information, comprising:
a first step of sending, by traffic information association apparatuses of a plurality of vehicles, location information or navigation information to a social network server;
a second step of sending, by the social network server, friend group information to the traffic information association apparatuses, wherein the friend group information comprises a friend group of a first vehicle generated based on a second vehicle within a specific distance from the first vehicle, a third vehicle moving on a road identical with a road of the first vehicle, a fourth vehicle having a second destination within a specific distance from a first destination of the first vehicle or a combination of the second, the third, and the fourth vehicles based on the location information;
a third step of sending, by the first traffic information association apparatus of the first vehicle, event-related traffic data to the social network server when detecting an event comprising a driver state, a vehicle state, a road state, a road condition or a combination of the driver state, the vehicle state, the road state, and the road condition; and
a fourth step of posting, by the social network server, the event-related traffic data on a first social network service area of a first friend group of the first vehicle.

11. The method of claim 10, further comprising a step of extracting traffic information from messages on wireless communication of a mobile device of a user who uses the social network service of the social network server,
wherein the traffic information is transmitted to the social network server, mined by the social network server, posted on a second social network service area of a plurality of friend groups of the social network service comprising the first social network service area, and shared by mobile devices of a plurality of users or traffic information association apparatuses belonging to the plurality of friend groups.

12. The method of claim 10, further comprising a step of sending, by the social network server, the event-related traffic data or an emergency message generated based on the event-related traffic data to the traffic information association apparatus within the friend group or a mobile device of a predetermined message recipient based on a result of a determination of importance of the event-related traffic data, after the third step.

13. The method of claim 12, wherein:
the driver state comprises driving while drowsy,
the vehicle state comprises sudden braking, a breakdown, a car accident or a combination of the sudden braking, the breakdown, and the car accident,
the road state comprises ice formation, slipperiness, a swept-away road, an obstacle or a combination of the ice formation, the slipperiness, the swept-away road, and the obstacle,
the road condition comprises a traffic jam, delayed traffic or smooth traffic, and
the importance has a highest importance in the driving while drowsy, the breakdown, the car accident, the swept-away road, or the traffic jam as a user definition event.
